(19) United States
(12) Patent Application Publication
(10) Pub. No.: US 2007/0178889 A1
(43) Pub. Date: Aug. 2, 2007

(54) Advertising on mobile devices

(75) Inventors: Mark L. Cortegiano, Melville, NY (US); Stephen T. Rollin, Marlborough, MA (US)

Correspondence Address: Brooks & Cameron, PLLC;Suite 500, 1221 Nicollet Avenue, Minneapolis, MN, 55403, US

(73) Assignee: XcellaSave, Inc.

(21) Appl. No.: 11/345,204

(22) Filed: Feb. 1, 2006

(51) Int. Cl. H04Q 7/22

(52) U.S. Cl. 455/414.3

(57) ABSTRACT

Devices, computer readable media, and systems including program instructions are provided for advertising on mobile phones. A device embodiment includes a mobile phone with program instructions executable to display a single stream of advertising formed from a number of advertising channels, receive a change input for a particular change to the single stream of advertising, and change the single stream of advertising according to the change input.

### BACKGROUND

In the field of telecommunications, mobile devices are increasingly used for more than simple voice and text communication. Mobile devices are now capable of displaying various forms of advertising content including interactive static, animated, and video images, audio files, web/WAP (Wireless Access Protocol) pages, or combinations of these forms. Advertisers provide such advertising content, which typically includes a brand name, such as a name of a particular product, service, and/or company. A growing number of advertisers are also providing advertising content that includes a brand name as well as associated content, such as games, short-form video, animation, or consumer marketing material such as surveys, coupons, or promotions.

However, the advertising content available to mobile devices is often difficult to access and preview before downloading or purchasing. Indeed, most advertising content must be advertised or marketed in some form to the consumer, and listed in a catalog, deck or file for the consumer to access and download. Displaying advertising or marketing information becomes essential for the distribution of any advertising content intended for the mobile device.

To date, advertising on mobile devices has been limited to banner advertisements and pop-up advertisements on wireless enabled personal computers, and text messages (SMS/MMS) on mobile telephones and PDAs. Nonetheless mobile devices, and particularly mobile telephones and PDAs are a practical advertising medium since many mobile device users spend significant amounts of time with their mobile devices. Moreover, mobile devices receive information, and particularly advertisements through a transceiver and display the advertising content on a screen. However, there are some difficulties with advertising on mobile devices.

One difficulty with advertising on mobile devices is finding ways to make mobile device advertisements appeal to and be receivable to mobile device users. For example, in the United States, the Federal Communications Commissions (FCC) restricts unsolicited advertising to mobile phones. This has been overcome using text messaging to allow the user to opt-in to the advertising content contained in the text message. But text messaging requires that the user pay for the advertisement by consuming valuable transmission minutes from the consumer's mobile telephone plan. Additionally, text messaging is largely text based, with limited graphic capability and supports only one advertising message or campaign at a time. Text messaging also requires significant participation or set-up from the user—going to the message inbox, opening individual messages, and following the prompts of the message to access a web/WAP page. This required set-up also does not appeal to some mobile device users.

Furthermore, some displays of mobile device advertisements cannot be changed by the mobile device user which further restricts the amount of advertising content that can be displayed. This lack of control does not appeal to some mobile device users. Some mobile device advertisements require significant set-up before they can be displayed by the mobile device user.

There are also various technical difficulties with advertising on mobile devices. Some mobile device advertising requires multiple applications to execute on a mobile device in order to display different advertisements. These multiple applications can sometimes overload a mobile device's operating system, causing the device to malfunction. Some mobile device operating systems cannot automatically initiate an application to display advertisements. Also, many devices are only able to display advertising content through a web/WAP portal, requiring additional transmission time from the user to view the advertising information.

### BRIEF DESCRIPTION OF THE DRAWINGS

FIG. 1 is an embodiment of a communication system suitable to implement embodiments of the present disclosure and illustrating connectivity to different network types.

FIGS. 2A-2B illustrates an operational embodiment of a system for advertising on mobile phones according to the present disclosure.

FIG. 3 illustrates an operational embodiment of instruction execution for control of advertising on mobile phones according to the present disclosure.

FIG. 4 illustrates another operational embodiment of instruction execution for control of advertising on mobile phones according to the present disclosure.

### DETAILED DESCRIPTION

Embodiments of the present disclosure include devices, computer readable media, and systems including program instructions for advertising on mobile phones. A device embodiment includes a mobile phone with program instructions executable to display a single stream of advertising formed from a number of advertising channels by a channel manager. The instructions are executable to receive an input to change to the single stream of advertising and change the single stream of advertising based on the change input.

Embodiments of the present disclosure described herein can be performed by software and/or firmware (i.e., computer executable instructions), hardware, application modules, and the like, executable and/or resident on systems, ASICs, and devices shown herein or otherwise. The embodiments of the present disclosure are not limited to any particular operating environment or to instructions written in any particular programming language. Software, firmware, and/or processing modules, suitable for carrying out embodiments of the present disclosure, can be resident in one or more devices or locations. Processing modules can include separate modules connected together or several modules on an application specific integrated circuit (ASIC).

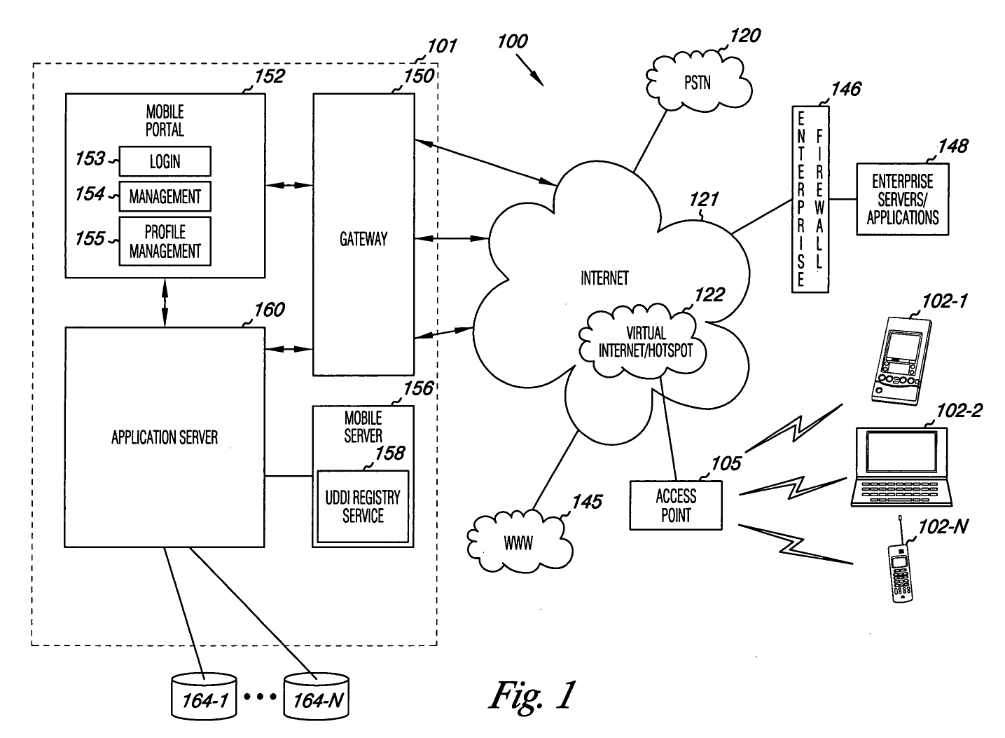

FIG. 1 is an embodiment of a communication system 100 suitable to implement embodiments of the present disclosure and illustrating connectivity to different network types, e.g., the public switched telephone network (PSTN) 120, the Internet 121, wireless networks 105, etc. Mobile devices 102-1, 102-2, . . . , 102-N, e.g., portable wireless devices, can include a wireless network interface such as a wireless transceiver, wireless network interface card, etc. These mobile devices, 102-1, 102-2, . . . , 102-N can include wireless enabled personal digital assistants (PDAs), communication handsets such as multifunction phones, Blackberry devices, laptop computers, among others to name a few.

Each of these mobile devices 102-1, 102-2, . . . , 102-N may have different features and function capabilities dependent upon a particular device type and applications provided thereon. That is, some devices may include features such as color displays and include application functionality that provides for instant messaging (IM), conferencing, streaming video, push to talk (PTT) capabilities, etc. Embodiments of the invention, however, are not limited to these examples. The mobile devices 102-1, 102-2, . . . , 102-N can include a Java 2 Platform Micro Edition (J2ME) OS which is a version of the Java 2 OS for cellphones, PDAs and consumer appliances. By way of example and not by way of limitation, such mobile devices 102-1, 102-2, . . . , 102-N can connect to access points 105 in a wireless network according to various RF protocols, e.g., global system for mobile general packet radio service (GSM GPRS), evolution data only (EV-DO), Bluetooth, Wi-Fi, etc.

An access point 105 conducting RF communication with such various mobile devices 102-1, 102-2, . . . , 102-N, can include a base station in a mobile network and/or a wireless router/transceiver in a wireless LAN and can be a wireless “hot-spot” such as a Bluetooth or Wi-Fi access point in a public location. Embodiments of the invention, however, are not limited to these examples. Access points 105 can provide a wireless to wireline connection for access to the Internet 121. A virtual ISP 122 can exist within an Internet connection 121 which can facilitate Internet connection with the wireless access point 105 and handle roaming access, billing, and the like.

The Internet 121 can have various connections, e.g., through gateways using TCP/IP, to the PSTN 120, to the world wide web (WWW) 145, etc. A service delivery platform (SDP) 101 is illustrated having connections to the Internet 121, the PSTN 120, and the WWW 145. The SDP 101 is shown having a gateway 150 for handling voice, data, and video traffic, etc. In some embodiments the gateway 150 can provide authentication, access, and billing. The gateway 150 to the SDP 101 can interface with a mobile portal 152 which can include a server that deploys portal services, such as login 153, management 154, and profile management 155, to a public web site or internal intranet.

FIG. 1 also illustrates a mobile server 156 accessible by the mobile portal 152. The mobile server 156 can include access to a universal description, discovery and integration (UDDI) database 158. The mobile server 156 is accessible by the mobile portal 152 via an application server 160. According to embodiments of the disclosure the application server 160 provides a web services interface. The application server 160 having the web services interface can also access one or more third party databases, e.g., 164-1, . . . , 164-N, and/or servers among different networks.

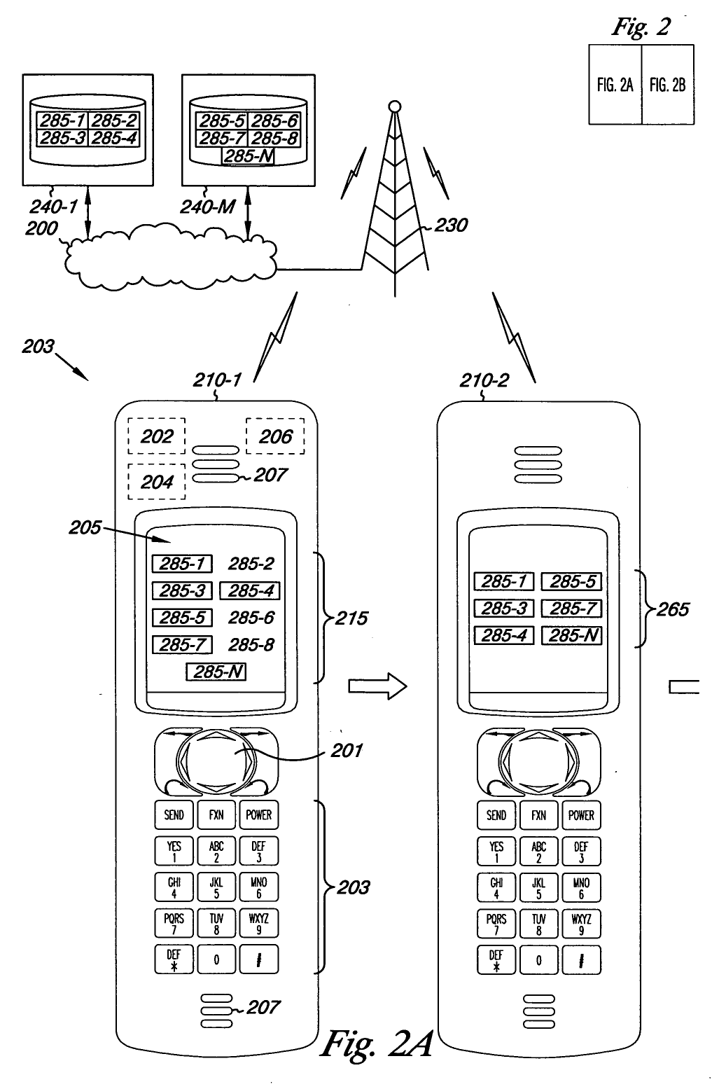

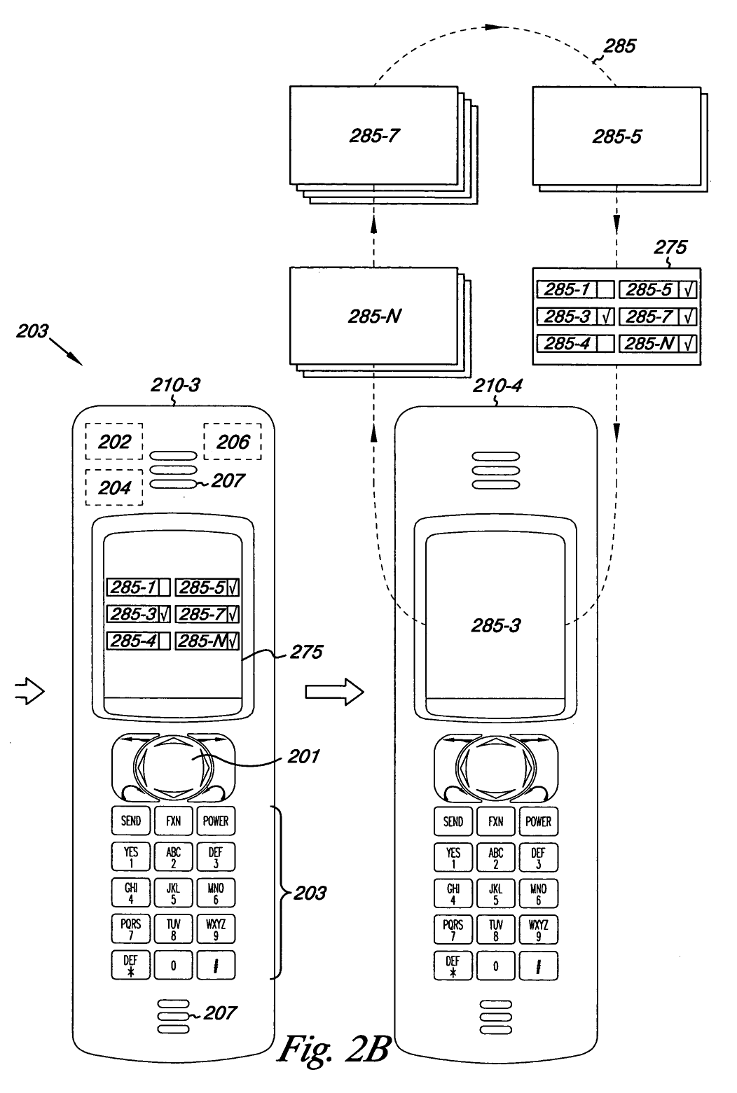

FIGS. 2A-2B illustrates an operational embodiment of a system for advertising on mobile phones according to the present disclosure. While FIGS. 2A and 2B are discussed with reference to a mobile phone, the reader will appreciate that embodiments are not limited to use with a mobile phone and that other mobile devices, including personal digital assistants (PDAs), handheld computers, pagers, handheld video game consoles, digital media players, digital cameras, global positioning system receivers, MP3 players, etc., can be used with the embodiments of the present disclosure, e.g., mobile devices shown as 102-1, 102-2, . . . , 102-N in FIG. 1.

FIGS. 2A-2B illustrate a mobile phone 203 in an example operational sequence, shown as 210-1, 210-2, 210-3, and 210-4. In FIG. 2A the mobile phone 203 is illustrated having the ability to connect to a communication system such as the communication system 100 shown in FIG. 1. That is, the mobile phone 203 is illustrated communicating according to a wireless protocol with a transceiver tower, e.g., base station, 230. The base station 230 can provide access via a network 200 to various application servers 240-1, . . . , 240-M. The designator “M” is used to indicate that a number of application servers can be accessed via one or more network 200 connections as described in connection with FIG. 1.

As illustrated with reference to the mobile phone at 210-1 the mobile phone 203 includes processor 202, memory 204, and transceiver 206 resources. The mobile phone 210 further includes a number of input keys 203, a toggle or softkey input 201, a display 205, and a speaker and microphone 207. The processor 202, memory 204, and transceiver 206 resources can communicate with and interact with the input keys 203, display 205, etc.

Executable instructions are storable in the memory 204 and executable by the processor 202 to perform various functions according to embodiments of the present disclosure. Memory 204 can additionally store various information, e.g., information relating to particular, available, advertising content as well as the advertising content itself. This advertising content can include a brand name such as a name of a particular product, service, and/or company, as well as associated content, such as games, short-form video, animation, or consumer marketing material. For example, as will be described in more detail below, the memory 204 can store information that represents a number of advertising channels that may be provided to the display 205. The memory 204 can store various audio and visual content associated with the number of advertising channels, e.g., the advertisement content itself, that may be provided to the display 205. The memory 204 of the mobile phone 210 can include an operating system such as J2ME stored in a read only memory (ROM). The memory 204 can also include random access memory (RAM), flash memory, etc. Thus, various memory 204 on the mobile phone 210 is available to store program instructions, routines, and applications.

In the operational sequence embodiment shown at 210-1 the mobile phone 203 is illustrated displaying information 215 associated with a number of available channels. For example, at 210-1 program instructions provided to the mobile phone 203 are executing to display information 215 about a number of advertising channels 285-1, 285-2, 285-3, . . . , 285-N. The designator “N” is used to indicate that embodiments are not limited to the number of channels which may have information provided to the display 205 of the mobile phone 203. According to various embodiments, program instructions on the mobile phone 203 can execute to store information about a number of channels, e.g., advertising channels.

In the present disclosure reference will be made to advertising channels for ease of reference. However, the reader will appreciate that the number of channels described herein can include channels associated with content other than advertising, e.g., weather alerts, news information, sports, financial information, etc. Information as used herein can include program applications to display the various content and content as used herein can include the data, voice, video, graphics, etc.

In the operational sequence embodiment shown at 210-1, program instructions on the mobile phone 203 can execute to receive a selection input for one or more particular channels among the number of advertising channels 285-1, 285-2, 285-3, . . . , 285-N. At operational sequence 210-1, advertising channels 285-1, 285-3, 285-4, 285-5, 285-7, and 285-N are shown enclosed in a rectangle to indicate that a selection input has been received in association with each of these respective advertising channels. Conversely, in this embodiment, channels 285-2, 285-6, and 285-8 are illustrated without an enclosing rectangle to indicate that a selection input has not been received in association with each of these respective channels. One of ordinary skill in the art will appreciate the various manners in which one or more channels on the display 215 of the mobile phone 203 may be accentuated, e.g., with color, highlighting, etc., to differentiate between channels which have received a selection input and those that have not. Additionally, the reader will appreciate the manner in which one or more selection inputs can be provided to the mobile phone 203, e.g., via an input key 203, toggle key 201, touch screen display, etc.

In various embodiments of the present disclosure, information about an advertising channel can include a preview channel for that advertising channel. Program instructions can execute to store a preview channel on the mobile phone 203, with one or more screens that include a portion of advertising content available for a particular advertising channel. For example, a particular advertising channel can include a screen with a short-form video, a screen with an image of a particular brand name, and a screen with a coupon. In this example, a preview channel for that particular advertising channel can include a screen with a portion of the short-form video and a screen with the image of the particular brand name, but not the screen with the coupon. Such a preview channel allows a mobile phone user to preview a portion of an advertising channel before selecting the channel with a selection input. In various embodiments, a preview channel can also include a prompt for a selection input, for the particular advertising channel being previewed.

Each channel chosen by a selection input can be defined as a subscription of the mobile phone 203 to the one or more particular channels selected, e.g., 285-1, 285-3, 285-4, 285-5, 285-7, and 285-N. As will be described in more detail below, features of the subscription associated with each channel can include; time sensitivity, an auto-start capability, a monetary value, an alert, auto-caching, a cache period, an update frequency, user profile information, etc. Embodiments are not limited to these examples.

In the operational sequence embodiment shown at 210-1, program instructions on the mobile phone 203 execute to transmit the selection inputs to one or more application servers 240-1, . . . , 240-M via its wireless network connection, e.g., 230 and 200. Thus, in the example embodiment at 210-1, the mobile phone 203 executes instructions to transmit a signal including the selection input for advertising channels 285-1, 285-3, 285-4, 285-5, 285-7, and 285-N. According to various embodiments, the selection input for advertising channels 285-1, 285-3, 285-4, 285-5, 285-7, and 285-N can be transmitted as a text message, a short message service (SMS) message, or a signal of some other format. Embodiments are not limited to these examples. In various embodiments, program instructions on the mobile phone 203 can also execute to transmit a unique token with the selection input to the one or more application servers 240-1, . . . , 240-M. This unique token can include distinct data, which can be used to identify the particular mobile phone 203 transmitting the selection input.

The embodiment of FIG. 2A illustrates that various, different, application servers 240-1, . . . , 240-M can contain the content, e.g., advertising content, associated with the number of advertising channels identified by the selection input. Hence, in the example illustrated application server 240-1 contains advertising content associated with advertising channels 285-1, . . . , 285-4 and application server 240-M is illustrated as containing advertising content associated with advertising channels 285-5, . . . , 285-N. Embodiments are not limited to the order or location of the content associated with the various number of content channels 285-1, . . . , 285-N available to a particular mobile phone. Likewise, embodiments are not limited to the manner in which the selection input is correctly routed to the appropriate application servers 240-1, . . . , 240-M containing the content associated with the number of advertising channels 285-1, . . . , 285-N across one or more networks such as illustrated in FIG. 1.

Program instructions on the respective application servers 240-1, . . . , 240-M can execute to transmit one or more particular advertising channels associated with the selection input back to a particular mobile phone. For example, program instructions on the servers 240-1, . . . , 240-M can execute to use a unique token received from a particular mobile phone, e.g., 203, to identify the mobile phone 203 and to determine a play list of advertising channels to return to the mobile phone 203.

In the operational sequence embodiment shown at 210-2, program instructions on the application servers 240-1, . . . , 240-M execute to transmit one or more particular advertising channels of the play list to the respective mobile phone 203. Thus, in this example application server 240-1 delivers advertising channels 285-1, 285-3, and 285-4, based on the received selection input, back to the mobile phone 203 and application server 240-N delivers advertising channels 285-5, 285-7, and 285-N, based on the received selection input, back to the mobile phone 203.

According to various embodiments, program instructions provided to the mobile phone 203 execute to download the one or more particular advertising channels 285-1, 285-3, 285-4, 285-5, 285-7, and 285-N to memory 204 of the mobile phone 203 and to store the one or more particular advertising channels 285-1, 285-3, 285-4, 285-5, 285-7, and 285-N in a manner that the one or more particular advertising channels 285-1, 285-3, 285-4, 285-5, 285-7, and 285-N can be displayed on the mobile phone 203 as a single stream of advertising content formed from the one or more particular advertising channels 285-1, 285-3, 285-4, 285-5, 285-7, and 285-N. Thus, at operational sequence 210-2, program instructions execute to download advertising channels 285-1, 285-3, 285-4, 285-5, 285-7, and 285-N and can execute to provide information associated with advertising channels 285-1, 285-3, 285-4, 285-5, 285-7, and 285-N to the display 205 of the mobile phone 203.

According to various embodiments, program instructions on the application servers 240-1, . . . , 240-M execute to deliver the content of the one or more particular advertising channels 285-1, 285-3, 285-4, 285-5, 285-7, and 285-N, other information, e.g., descriptive information 265 for display, associated with the one or more particular advertising channels 285-1, 285-3, 285-4, 285-5, 285-7, and 285-N, and program application instructions executable to display the one or more particular advertising channels 285-1, 285-3, 285-4, 285-5, 285-7, and 285-N as a bundle, meaning that the one or more particular advertising channels 285-1, 285-3, 285-4, 285-5, 285-7, and 285-N can be presented as a single stream of rotating advertising content displayed on the screen.

In various embodiments of the present disclosure, program instructions on the mobile phone 203 can also execute to automatically retrieve updated versions of one or more particular advertising channels, based on a selection input, and to automatically download the updated versions from application servers 240-1, . . . , 240-M. As shown at operational sequence 210-2, program instructions on the mobile phone 203 execute to display information 265 about the one or more particular advertising channels 285-1, 285-3, 285-4, 285-5, 285-7, and 285-N, which the mobile phone 203 downloaded.

In the operational sequence embodiment shown at 210-3 in FIG. 2B, program instructions on the mobile phone 203 execute to display a prompt 275 for an input to change the single stream of advertising content formed from advertising channels 285-1, 285-3, 285-4, 285-5, 285-7, and 285-N. As shown at 210-3, the displayed prompt 275 includes information related to displaying the advertising channels 285-1, 285-3, 285-4, 285-5, 285-7, and 285-N. In the example shown at 210-3, the displayed prompt 275 indicates that advertising channels 285-3, 285-5, 285-7, and 285-N are enabled for display on the mobile phone 203 and advertising channels 285-1 and 285-4 are disabled from display on the mobile phone 203.

According to various embodiments, program instructions on the mobile phone 203 can execute to receive an input to change the single steam of advertising content formed from the advertising channels 285-1, 285-3, 285-4, 285-5, 285-7, and 285-N and to change the single stream of advertising content based on the received input. As used herein, an input to change the single stream of advertising content can include an input to add, remove, enable, or disable one or more particular advertising channels. For example, at 210-3, program instructions have executed in response to an input to change the single stream of advertising content and disable advertising channels 285-1 and 285-4. In various embodiments in which a particular advertising channel has an expiration date, program instructions can execute to change, e.g., remove or disable, the particular channel on and/or before the expiration date. Likewise, in various embodiments in which a particular advertising channel has an activation date, program instructions can execute to change, e.g. add or enable the particular channel on and/or after the activation date.

As used herein the term “remove” is intended to mean that a particular advertising channel is taken entirely out of the single stream of advertising content and the term “disable” is intended to mean that a particular advertising channel is temporarily taken out of the single stream of advertising content but can be subsequently re-enabled without re-downloading the particular channel from a respective application server 240-1, . . . , 240-M to the mobile phone 203. Additionally, the term “add” is intended to mean that a particular advertising channel can be newly provided to the single stream of advertising content and the term “enable” is intended to mean that a particular advertising channel is affirmatively selected to be presented in the single stream of advertising content.

Based on the input to change the single stream of advertising content received at operation sequence 210-3, program instructions on the mobile phone 203 can execute to form a single stream of advertising from the selected number of advertising channels, e.g., 285-3, 285-5, 285-7, and 285-N. Operational sequence 210-4 pictorially represents that the program instructions have executed to form a single stream of advertising content, illustrated in loop fashion as 285, on the mobile phone 203 from advertising channels 285-3, 285-5, 285-7, and 285-N, which the mobile phone 203 downloaded and which are enabled for display.

As illustrated at 210-4, program instructions on the mobile phone 203 can also execute to form a single stream of advertising that includes a prompt for an input to change the single stream of advertising content 285. In operational sequence 210-4, program instructions on the mobile phone 203 execute to form the single stream of advertising content 285 with a prompt 275 for an input to change the single stream of advertising content 285. In this embodiment, the single stream of advertising 285 is a loop, which includes advertising channel 285-3, the prompt 275, advertising channel 285-5, advertising channel 285-7, and advertising channel, and 285-N. Further, as shown in operational sequence 210-4, each particular channel can include a series of screen displays, referred to as a “deck”. For example, channel 285-5 is illustrated having two screen displays in its deck, channel 285-7 is illustrated having four screen displays in its deck, and channel 285-N is illustrated having three screen displays in its deck. In various embodiments of the present disclosure, in a deck with multiple screens, various screens can display various forms of advertising content. As an example, a deck with four screens can display a first screen in the form of a static image, a second screen in the form of a video image, a third screen in the form of an animated image, and a fourth screen in the form of a web page. Embodiments are not limited to the number, content, or form of screen display in the deck of a particular channel.

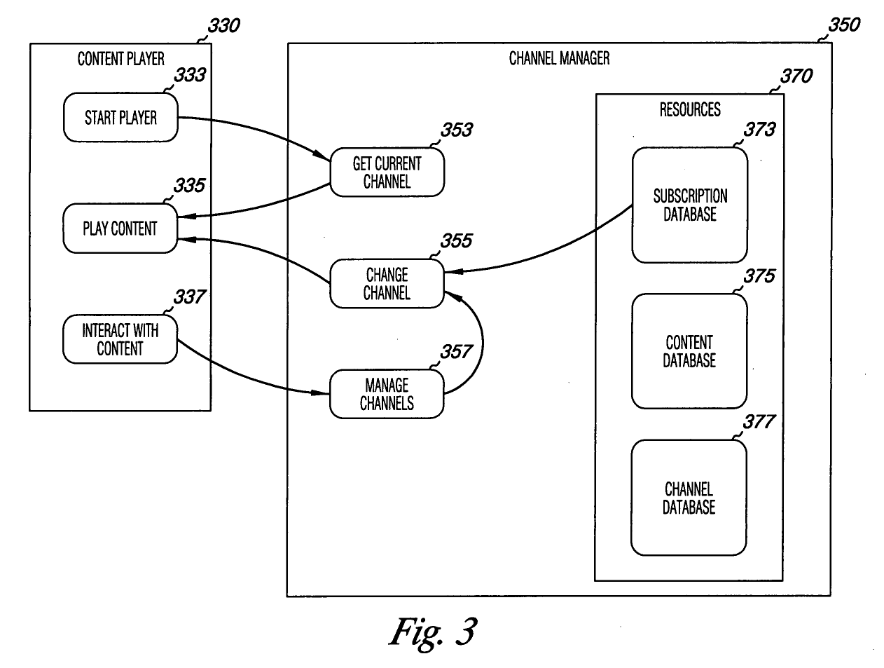

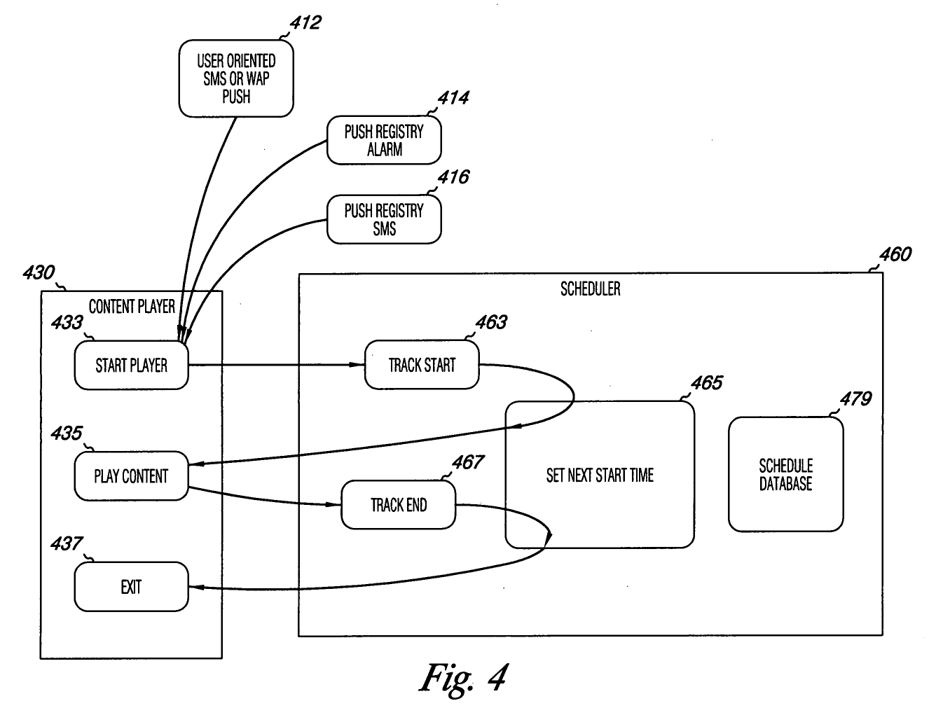

As noted previously, each particular channel chosen by a selection input can be considered a subscription of the mobile phone 203 to the various channels selected. Each of the particular channels can have particular features associated therewith. A feature of the subscription associated with a particular channel can include time sensitivity, e.g., a start time, end time, and calendar date, etc. A feature of the subscription associated with a particular channel can include an auto-start capability as will be described in more detail in connection with FIGS. 3 and 4. A feature of the subscription associated with a particular channel can include a monetary value, e.g., a monetary cost to a content provider to have the particular content of the channel displayed on a particular mobile phone and can have a monetary value in the form of a cost discount to a user of the mobile phone. An example of such a monetary credit to a user of a mobile phone is described in copending U.S. patent application Ser. No. 10/978,516, entitled “Method of Advertising on Digital Cellular Telephones and Reducing Costs to the End User”, filed on Nov. 1, 2004.

Another feature of the subscription associated with a particular channel can include an alert to notify a user of a mobile phone of a particular message, meeting, etc. A feature of the subscription associated with a particular channel can include an auto-caching capability and cache period where particular channels and their associated decks in the single stream of advertising content are cached in memory 204. This feature can include the ability to automatically download additional channels and/or screen displays for a particular channel without user intervention. A feature of the subscription associated with a particular channel can include an update frequency for how often content, e.g., advertising, associated with a particular channel is changed. A feature of the subscription associated with a particular channel can also include user profile information, e.g., personal information relating to a user (such as interest, hobbies, etc.) of a particular mobile device. Embodiments are not limited to these examples.

According to various embodiments, program instructions provided to the mobile phone 203 in association with the above operational sequence can be provided as a single application executable as part of a content player and channel manager (as discussed in more detail in FIGS. 3 and 4) on the mobile phone 203.

FIG. 3 illustrates an operational embodiment of instruction execution for control of advertising on mobile phones according to the present disclosure. FIG. 3 shows a content player 330 and a channel manager 350. The content player 330 and the channel manager 350 are program applications, which can be stored in a memory of a mobile phone and executed by a processor of a mobile phone.

The content player 330 and the channel manager 350 each contain program instructions, which can execute to perform various functions. The content player 330 contains program instructions to start the content player 333, to play advertising content 335 on the content player 330, and to allow a user to interact with the advertising content 337 playing on the content player 330. The channel manager 350 contains program instructions to get a current advertising channel 353, to change an advertising channel 355, and to manage advertising channels 357. The channel manager 350 also contains program application resources 370, which include a channel subscription database 373, an advertising content database 375, and a channel database 377.

The content player 330 can be started in various ways. A mobile phone user can provide an input to the mobile phone to start the content player 333. For example, a mobile phone user may enter a store and desire to see advertising for the store on the mobile phone. This user can provide a keypad input to start the content player 333. A content player can also be started as described in connection with FIG. 4.

The program instructions to start the content player 333 can prompt the channel manager 350 to get the current channel 353. A current channel is an unexpired advertising channel, which is presently scheduled to be displayed on the mobile phone. A scheduler can determine which channels are presently scheduled to be displayed, as described in connection with FIG. 4. Each advertising channel includes meta-data with an expiration date for that channel. Program instructions in the channel manager can execute to compare the expiration date for a channel with the current date, to determine whether the channel has expired.

The program instructions to get the current channel 353 can retrieve the current channel from a memory on the phone or can download the channel from a server, in various embodiments. If the current channel available in the content database 375, then program instructions can get the current channel 353 from the content database 375. If the current channel is not available in the content database 375, then program instructions can get the current channel 353 by requesting the channel from a server and downloading the channel, as described in connection with FIG. 2. Once the channel manager 350 has gotten the current channel, it can send it to the content player 330.

The program instructions to get the current the current channel 353 can execute to prompt the content player 330 to execute program instructions to play the content 335 on the content player 350. For example, playing advertising content on a mobile phone can include displaying various visual advertisements on a screen of the mobile phone and/or playing various audio advertisements on a speaker of the mobile phone. In an embodiment of the present disclosure, playing advertising content 335 can include displaying a single stream of advertising content formed from a number advertising channels and including a prompt to change the stream, as described in connection with FIG. 2.

A user can interact with the advertising content 337 playing on the content player 330 by providing an input to change the single stream of advertising. For example, a mobile phone user may enter a store and see a sign prompting mobile phone users to add an advertising channel for the store to their mobile phones. The program instructions that allow a user to interact with content 337 can also execute to prompt the channel manager 350 to execute program instructions to manage channels 357 in response to a user's interaction with the content 337. For example, a mobile phone user can provide an input to the mobile phone that interacts with a single stream of advertising being played on a mobile phone by the content player 330. In this example, this interaction can prompt the channel manager 350 to perform various channel management functions on a single stream advertising. That is, program instructions associated with the content player 330 and channel manager 350 can execute in cooperation to achieve various channel management functionality.

Depending on the channel management functions performed, program instructions to manage channels 357 can also execute to prompt the channel manager 350 to execute program instructions to change a channel 355. For example, program instructions associated with the content player 330 and the channel manager 350 in executing to change channels 355 can add, remove, enable and/or disable one or more particular advertising channels as part of the manage channels 357 function. The change channel function 355 can in turn execute program instructions to prompt the content player 330 to play content 335, including changes made by the change channel function 355.

The databases in the resources 370 contain various data. The subscription database 373 contains data about particular advertising channels to which a mobile phone user subscribes. For example, the subscription database 373 can contain a play list, describing these channels. The content database 375 contains particular advertising content that corresponds with the particular advertising channels to which the mobile phone user subscribes and which the mobile phone user has downloaded. The channel database 377 contains information including content relating to particular advertising channels. For example, the channel database 377 can contain information about various advertising channels to which a mobile phone user could subscribe.

FIG. 4 illustrates an operational embodiment of instruction execution for control of advertising on mobile phones according to the present disclosure. FIG. 4 shows a content player 430 and a scheduler 460. The content player 430 and the scheduler 460 are program routines, which can be stored in a memory of a mobile phone and executed by a processor of a mobile phone.

The content player 430 and the scheduler 460 each contain program instructions which can execute to perform various functions. The content player 430 contains program instructions to start the content player 433, play content on the content player 435, and exit the player 437. The scheduler 460 contains program instructions to track a start time 463 of playing content 435 on the content player, to track an end time 467 of playing content 435 on the content player 430, and to set a next start time 465 for playing content 435 on the content player 430.

The scheduler 460 also contains a schedule database 479. The schedule database 479 contains schedules for displaying advertising information on a mobile phone at one or more particular times. Program instructions in the scheduler 460 can execute to use the schedules in the schedule database 479 to set a next start time 465 to start playing content 433, by displaying advertising information, at a particular time. Program instructions in the scheduler 460 can also execute to use a tracked start time 463 and/or a tracked end time 467 to set a next start time 465 to start playing content 433.

The relevance of these novel components is to drawn to the fact that it may be desirable to provide a content application (e.g., an advertising application to display of a single stream of advertising formed from a number of advertising channels such as 285-1, . . . , 285-N in FIGS. 2A and 2B) to a mobile phone and run this particular content application at particular times. In the embodiment of FIG. 4, the content player 430 and the scheduler 460 include executable instructions which can interact with the operating system (OS) of a particular mobile phone to launch a content application (e.g., “advertising application”) on the mobile phone even in the case where routines associated with the OS are not natively written to be externally started. For example, with mobile phones using the Java 2

Platform Micro Edition (J2ME) OS environment, midlets are not externally started.

In the J2ME OS environment, midlets are the mobile phone or pager applications written in J2ME. In this environment, a mobile information device profile (MIDP) provides the application programming interface (API) for mobile phones and pagers. The MIDP provides support for a graphical interface, networking and storage of persistent data for the mobile information device (MID) profile applications, i.e., midlets.

Since midlets are not externally started in the J2ME OS environment, the J2ME OS environment presents various issues to providing an automatic, or particular time-based, display of channel content on a mobile phone. As noted, among these issues is the fact that, in the J2ME MIDP 2.0 environment, applications are not supposed to start themselves. Additionally, there is no such thing as a native screensaver which may otherwise be used to trigger an advertising application.

There is also no functionality for detecting user activity when an application is not running, e.g., a call is not being placed from out received to the mobile phone. As described in the above mentioned copending patent application “Method of Advertising on Digital Cellular Telephones and Reducing Costs to the End User”, such idle time when the mobile phone is not otherwise being used could be effectively be used to run an advertising application and display different content to a user of a mobile phone.

There is likewise, no functionality for detecting power state transitions, i.e., “turn on”, “turn off” states. As noted in the above copending patent application, such power state transitions, if detectable, could similarly be used to launch and run and advertising application and display different content to a user of a mobile phone in a non-intrusive manner. Further, there is no native functionality to start a J2ME application when a mobile phone powers on. Again, as noted in the above copending patent application, the ability to start a particular mobile phone application upon a power on event could effectively be used to launch an advertising application having executable instructions to retrieve particular content associated with the advertising application from a server on a network.

Program embodiments of the present disclosure, pictorially represented in connection with FIG. 4, overcome the above obstacles and hurdles. It is noted that the program embodiments are provided with an appreciation that J2ME provides a mechanism to allow external events to start a midlet called the “push registry”. However, only one push registry alarm can be registered on the mobile phone at any point in time for a specific midlet. The example program embodiments described in the text that follows provide a device specific solution to starting a midlet in view of this restriction. While embodiments will be described in connection to issues relating to the J2ME OS environment, the reader will appreciate that embodiments of the present disclosure are not limited to this example environment.

The embodiment of FIG. 4 illustrates a number of manners in which particular routines in the OS of a mobile phone, which are not typically started externally, can be started to run an advertising application. As shown in FIG. 4, in order to display a single stream of advertising formed from a number of advertising channels (285-1, . . . , 285-N in FIGS. 2A and 2B), various “start” inputs, e.g., 412, 414, and 416, can be provided to the mobile phone to start the player 433 on the content player 430.

For example, input 412 illustrates a user oriented message to the mobile phone as can be generated by an application server, e.g., application servers 240-1, . . . , 240-M in FIGS. 2A and 2B, in a communication network. The user oriented message can take the form of a short message service (SMS) message, wireless application protocol (WAP) message, etc. Embodiments are not limited to these message types. Input 414 can be provided by program instructions executing in connection with a push registry alarm. And, input 416 can be provided by program instructions executing in connection with a push registry SMS.

Based on these various start inputs, e.g., 412, 414, 416, program instructions can execute to start the content player 430. In various embodiments, these start inputs, 412, 414, 416, can prompt a user of the mobile phone to start the content player 430. The program instructions of the content player 430 can execute to interact with the scheduler 460, which can further interact with the OS of the mobile phone to run various routines. In this manner, starting an application that can further start a J2ME midlet on a mobile phone is provided without having to rewrite the OS code.

As shown in the embodiment of FIG. 4, the program instructions associated with the content player 430 and the scheduler 460 can execute to implement a time-based approach to externally starting J2ME midlets, independent of underlying platform capabilities. FIG. 4 illustrates a number of particular features to the program embodiments. These features include the ability of the program instructions to be triggered and execute to start a J2ME midlet from a scheduled alarm, e.g., input 414. As program instructions associated with the scheduler 460 execute to start a track (“track start” 463), e.g., single stream of advertising content, the program instructions additionally execute as part of the scheduler to set a next start time, shown at 465. That is, the program instructions associated with the scheduler 460 can execute to plan out the next time the program application for displaying a single stream of advertising content (e.g., “advertising application”) is to start and execute to set the next alarm.

In devices that do not support the push registry alarm, program instructions can execute to start the advertising application by sending an advertising application directed SMS, e.g., input 416, from the an application server containing the particular advertising content (e.g., 240-1, . . . , 240-M in FIGS. 2A and 2B) to a particular “client midlet”, e.g., to the J2ME push registry.

Input examples 414 and 416 in effect represent virtual external events for starting an advertising application on the mobile. As shown in FIG. 4, in compliment to these virtual external events, the program instructions associated with the content player 430 and the scheduler 460 can additionally be started and executed by prompting a user to start the advertising application manually in response to a regular SMS and WAP push messages, e.g., input 412. Thus, program embodiments described herein effectively extend the ability to timely display different content to devices whose OS environment does include native screensavers, functionality for detecting such events as application inactivity, and power state transitions, and/or which do not include native functionality to start an particular application when the device powers on. According to various embodiments, such an advertising application can be provided to a mobile phone as a single application, including the ability to display a single stream of different content formed from a number of different content channels,

Although specific embodiments have been illustrated and described herein, those of ordinary skill in the art will appreciate that an arrangement calculated to achieve the same techniques can be substituted for the specific embodiments shown. This disclosure is intended to cover all adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that embodiments of the present disclosure require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A mobile phone device comprising:
a processor;
a memory, connected to the processor; and
program instructions storable in the memory and executable by the processor to:
display information about a number of advertising channels;
receive a selection input for a particular advertising channel; and
download the particular advertising channel.

2. The device of claim 1, wherein the program instructions are executable to display information about a number of advertising channels, wherein the number of advertising channels are stored on a number of servers.

3. The device of claim 1, wherein the memory stores the information about a number of advertising channels.

4. The device of claim 3, wherein the information about a number of advertising channels includes a preview channel for a particular advertising channel from the number of advertising channels.

5. The device of claim 1, wherein the program instructions are executable to display information about an available advertising channel in response to a search input.

6. The device of claim 1, including program instructions executable to transmit the selection input as a text message to a server.

7. The device of claim 1, including program instructions executable to transmit the selection input as a short message service message to a server.

8. The device of claim 1, including program instructions executable to transmit the selection input and a unique token to a server.

9. The device of claim 1, wherein the program instructions are executable to download a bundle of files including the particular advertising channel and an application to display a number of advertising channels.

10. A mobile phone device comprising:
a processor;
a memory, connected to the processor; and
program instructions storable in the memory and executable by the processor to:
display information about a number of advertising channels;
download a particular advertising channel, selected from the number of advertising channels; and
display the particular advertising channel in a single stream of advertising, wherein the particular advertising channel includes:
a first screen that includes a brand name; and
a second screen that includes associated content.

11. The device of claim 10, wherein the associated content includes associated content selected from the group including:
a game;
a short-form video;
an animation;
a survey;
a coupon; and
a promotion.

12. A mobile phone device comprising:
a processor;
a memory, connected to the processor; and
program instructions storable in the memory and executable by the processor to:
display a single stream of advertising formed from a number of advertising channels by a channel manager;
receive an input to change the single stream of advertising; and
change the single stream of advertising based on the change input.

13. The device of claim 12, including program instructions executable to form the single stream of advertising from a number of advertising channels by a channel manager.

14. The device of claim 12, including program instructions executable to assign a particular priority to each of the advertising channels in the single stream of advertising by the channel manager.

15. The device of claim 12, wherein the program instructions are executable to display an interactive channel in the single stream of advertising.

16. The device of claim 12, wherein the program instructions to display the single stream of advertising are a single program application.

17. The device of claim 12, wherein the program instructions are executable to display, in the single stream of advertising, a prompt for a change input for a particular change to the single stream of advertising.

18. The device of claim 12, wherein the program instructions are executable to receive the change input, wherein the change input includes an input selected from the group including:
an input to add a particular advertising channel to the single stream of advertising;
an input to remove a particular advertising channel from the single stream of advertising;
an input to enable a particular advertising channel in the single stream of advertising; and
an input to disable a particular advertising channel in the single stream of advertising.

19. The device of claim 18, wherein the program instructions are executable to change the single stream of advertising according to the change input before the particular channel expires.

20. A mobile phone device comprising:
a logic;
a memory, connected to the logic;
an operating system (OS), stored in the memory, wherein routines in the OS are externally started; and
program instructions storable in the memory and executable by the processor to externally start a particular routine in the OS, in order to display a single stream of advertising formed from advertising channels.

21. The device of claim 20, wherein the program instructions are executable to start the particular routine in response to a start input.

22. The device of claim 20, wherein the program instructions are executable to start the particular routine in response to a push registry short message service input.

23. The device of claim 20, wherein the program instructions are executable to start the particular routine in response to an alarm input available in the OS.

24. The device of claim 23, including program instructions executable to schedule the alarm input based on a particular time at which the particular routine started.

25. The device of claim 23, including program instructions executable to schedule the alarm input based on a particular time at which the particular routine ended.

26. The device of claim 23, wherein the OS is Java 2 Micro Edition.

27. The device of claim 26, wherein the particular routine is a midlet.

28. A computer readable medium having instructions storeable thereon and executable to cause a device to perform a method, comprising:
displaying on a mobile phone a single stream of advertising formed from advertising channels, which correspond with a play list; and
changing the single stream of advertising immediately in response to changes to the play list.

29. The medium of claim 28, wherein the instructions to perform the method of displaying advertising on a mobile phone are a single application.

30. The medium of claim 28, wherein the method includes automatically displaying the single stream of advertising according to a particular schedule.

31. The medium of claim 28, wherein the method includes automatically retrieving updated versions of the advertising channels.

32. The medium of claim 28, wherein the method includes displaying the single stream of advertising in response to a virtual external event.

33. A system for mobile phones, comprising:
a processor;
a memory, connected to the processor; and
program instructions storable in the memory and executable by the processor to:
receive from a mobile phone a selection input for a particular advertising channel;
determine a play list of advertising channels including the particular advertising channel; and
transmit to the mobile phone the advertising channels of the play list.

34. The system of claim 33, including program instructions executable to determine the play list by using a unique token received from the mobile phone.

35. The system of claim 33, including program instructions executable to transmit to the mobile phone a single application to display the advertising channels as a single stream of advertising on the mobile phone.
